(19) United States
(12) Patent Application Publication
(10) Pub. No.: US 2006/0229777 A1
(43) Pub. Date: Oct. 12, 2006

(54) System and methods of performing real-time on-board automotive telemetry analysis and reporting

(76) Inventors: Michael D. Hudson, Hillsboro, OR (US); Kelly M. McArthur, Hillsboro, OR (US)

Correspondence Address: GERALD B ROSENBERG;NEW TECH LAW, 260 SHERIDAN AVENUE, SUITE 208, PALO ALTO, CA, 94306-2009, US

(21) Appl. No.: 11/401,831

(22) Filed: Apr. 11, 2006

Related U.S. Application Data
(60) Provisional application No. 60/670,450, filed on Apr. 12, 2005.

(51) Int. Cl. G01M 17/00

(52) U.S. Cl. 701/29; 701/30

(57) ABSTRACT

Active diagnosis of current operating and potential fault conditions in the operation of the vehicle is implemented using a diagnostic controller interoperating with an on-board vehicle control system as installed within a vehicle. The diagnostic controller supports autonomous execution of diagnostic tests initiated dependent on the operational state of the vehicle. The control system includes a diagnostics control manager that autonomously selects test routines for execution at defined operational states, including in-service operational states, a monitor, responsive to sensor data retrieved in real-time from the on-board vehicle control system, operative to detect a current instance of the in-service operational state of the vehicle, and a diagnostic test scheduler operative to initiate execution of the diagnostic test routine upon detection of the current instance of the in-service operational state of the vehicle.

This application claims the benefit of U.S. Provisional Application No. 60/670,450, filed Apr. 12, 2005.

### BACKGROUND OF THE INVENTION

1. Field of the Invention

The present invention is generally related to automotive test systems and, in particular, to a wireless telemetry-based system enabling real-time diagnostics of automotive systems.

2. Description of the Related Art

Vehicles, including automobiles in particular, have implemented relatively sophisticated on-board data collection and diagnostic systems for a considerable number of years. Typically implemented as embedded processor systems, these electronic control units (ECUs), often generically referred to as on-board controllers, are used to monitor and control engine, exhaust and other operating vehicle functions. The monitoring and control operations are enabled by a network of sensors and actuators distributed at appropriate control points throughout the vehicle. The electronic control unit and associated network are generally referred to as the vehicle on-board control system.

Although implemented as proprietary controllers, the primary capabilities of vehicle on-board control systems and the protocols for communicating with these systems are subject to industry standard definition. Since approximately 1996, newly manufactured automobiles have included onboard diagnostics systems compliant with the On-Board Diagnostics II (OBDII) standard (Society of Automotive Engineers (SAE) standards J1979, Diagnostic Test Modes, J1962, Physical Connectors, J1850 Class B Communications Network Interface defining signaling and timings, and others).

In particular, the OBDII standard defines the form and electrical characteristics of a connector physically attached to a vehicle on-board controller and a communications protocol for exchanging commands and data through the connector. Specifically, the OBDII standard defines the form of a Data Link Connector (DLC) as a specific industry standard model 16-pin plug. The standard also specifies that the DLC connector must be located within three feet of the driver. Typically, the DLC connector is located within the engine compartment or, in some cases, concealed under the dashboard near the steering wheel. Placement within the engine compartment is typical given the requirement for physical connection to the on-board vehicle controller also resident in the engine compartment.

Currently, several relatively minor variants of the signaling protocols are in commercial use. All, however, implement at least the SAE J1979 standard defined command set to enable access to current and short term historical vehicle sensor data as collected by the on-board vehicle controller. Standard commands are implemented to support read-out of various vehicle performance codes, reflecting sensor values, that allow diagnostic evaluation of exhaust emissions, fuel use, ignition timing, engine speed and temperature, oil pressure, distance traveled and such other operating factors as typically needed for compliance with state mandated clean-air operation and reporting requirements. Individual code reports typically identify the source and sense value of a specific sensor present within the sensor network distributed throughout the vehicle. Other code reports can identify certain existing fault conditions.

In typical use, an external diagnostic analyzer station is physically connected through a data cable to the DLC connector in the context of a service bay. The most common conventional analyzers are fixed units or mounted on service carts with limited mobility. Defined series of analyzer commands can be issued to the on-board vehicle controller to elicit the information necessary to determine whether the operation of the vehicle complies with manufacturer or regulatory requirements. To accommodate service bay use, the vehicle is run either stationary or on a dynamometer. In addition to reading out current sensor values, conventional analyzer stations are capable of issuing commands to disable or alter the reported sense value of different sensors and to override the operation of select, typically engine control actuators. This allows for active diagnostic testing of the various sensors in a limited simulated exercise of the vehicle systems.

A number of enhanced vehicle on-board control system have been proposed over the years. These systems are variously targeted at improving the use and diagnostic capabilities of the on-board vehicle controllers. For example, U.S. Pat. No. 4,128,005, issued to Arnston et al., describes a now conventional service bay analyzer capable of automatic collection and presentation of diagnostic data. The service bay analyzer is a fixed site unit that connects to the automobile through a physical telemetry cable. Various engine sensors are polled during programmed operation to evaluate current performance. Sensor states are evaluated directly and also compared to an established operational state matrix to identify existing faulty components. As a use improvement, based on the diagnostic fault code, the service bay analyzer can then retrieve a repair or replacement procedure specific to the faulting component.

U.S. Pat. No. 5,041,976, issued to Marko et al., describes a diagnostic system intended to simplify automated processes of evaluating the sensor data collected by the on-board vehicle control systems. Implemented either as a component of an external stationary service bay analyzer or as a built-in component of the on-board vehicle controller, the diagnostic system operates sequentially to consolidate sensor data into discrete, fixed format vectors of values. This sequence of vectors is then applied at discrete intervals to an embedded neural network-based expert system for analysis. By using the consolodated, vectorized data as inputs, rather than the relatively unorganized direct sensor data, a relatively simple neural network is capable of automatically distinguishing among a variety of specific component failures.

U.S. Pat. No. 5,214,582, issued to Gray, describes a service bay diagnostic control station that enables selective overrides of control actuators nominally managed by the on-board vehicle controller. Manually initiated overrides enable limited simulation of operating conditions not otherwise achievable in the stationary, idle operation of a vehicle within the context of a service bay. By observing the results of a discretely forced full or partial fault condition, the sensor values and operational behavior of the on-board vehicle controller can be evaluated for appropriateness.

U.S. Pat. No. 5,711,021, issued to Book, describes a diagnostic system that manages the organization and presentation of sensor data on a graphical display. Current data from multiple sensors can be simultaneously shown. The current data can be overlaid with prior collected data to provide a historical operating perspective and thereby enables an enhanced understanding of the sensor data.

U.S. Pat. No. 6,263,268, issued to Nathanson, describes a wireless telemetry system that enables sensor data to be reported to a remote client for display. Rather than requiring a physical connection to an external test station, a complete diagnostic system is fully embedded and directly connected to the on-board vehicle control system. A network communications protocol server is also embedded with a transceiver to allow sensor data sets to be sent in response to remotely issued client requests. On-board sensor data can be diagnostically processed and stored locally pending client requests. Interactive exchange of individual OBD commands and responses is also supported.

Although not specific to automotive systems, U.S. Pat. No. 4,642,782, issued to Kemper et al., discloses a diagnostic system used to actively monitor, through a distributed sensor network, a complex industrial system. An embedded expert system operates against a database that includes rules developed by domain experts that relate sensor patterns to diagnostic conditions. Confidence values, also supplied by the domain experts, are included in the rules. The confidence values are used, in effect, to allow for the potential of degraded sensor data in the inference operations performed by the expert system.

On-board vehicle sensor networks continue to increase in complexity both in terms of the number of sensors and the different specific operating elements that are monitored and managed by the onboard electronic control unit. The commercial needs and regulatory requirements for continuously maintaining optimal vehicle operation and minimizing repair costs and out-of-service maintenance time due to component failures are also of increasing importance. Consequently, a need exists for an improved system for accessing information from various on-board control systems and diagnosing full and partial fault conditions that may occur within the operational systems of a vehicle.

### SUMMARY OF THE INVENTION

Thus, a general purpose of the present invention is to provide an efficient system for interfacing with an automotive vehicle on-board control system and to provide a more sophisticated diagnostics capability that is capable of identifying full and partial fault conditions, both present and predictively.

This is achieved in the present invention by providing a diagnostic controller interoperating with an on-board vehicle control system as installed within a vehicle to actively diagnose current operating and potential fault conditions in the operation of the vehicle. The diagnostic controller supports autonomous execution of diagnostic tests initiated dependent on the operational state of the vehicle. The control system includes a diagnostics control manager that autonomously selects test routines for execution at defined operational states, including in-service operational states, a monitor, responsive to sensor data retrieved in real-time from the on-board vehicle control system, operative to detect a current instance of the in-service operational state of the vehicle, and a diagnostic test scheduler operative to initiate execution of the diagnostic test routine upon detection of the current instance of the in-service operational state of the vehicle.

An advantage of the present invention is that the diagnostic controller is capable of analyzing, in real-time, sensor data received in all operating modes of the vehicle, including in particular during in-service use. Additionally the diagnostic controller is able to schedule and perform diagnostic tests at appropriate times in the operation of the vehicle, again including in particular during in-service use. Sensor data analysis performed during in-service use of the vehicle allows detection of even subtle and intermittent operation variances potentially predictive of impending component faults. In-service selection and execution of condition dependent diagnostic tests further aids in the identification of potential component faults through controlled perturbation of operational conditions specifically chosen to test for potentially identified faults. Testing under in-service conditions which cannot be simulated in service-bay contexts, is readily and safely performed by the diagnostic controller of the present invention.

Another advantage of the present invention is that the diagnostic controller implements a rules-based expert system to analyze sensor data and to autonomously select diagnostic tests that, when executed, will elicit additional sensor data particularly effective in furthering the operational evaluation of particular vehicle components including, in particular, those potentially approaching a fault condition. The diagnostic controller also maintains a historical record of sensor data available to the expert system to extend the capability of the expert system to identify variances suggestive of components approaching a fault condition.

A further advantage of the present invention is that the diagnostic controller can be implemented in a split component design where a minimal base component is installed in a vehicle and a preferably hand portable control and display unit. A wireless communications link between the base and control units allows the control unit to be easily moved between different vehicles, requiring duplication only of the base unit in each vehicle, and un-tethered operation of the control unit conveniently from within the passenger compartment of a vehicle or further remote location while the vehicle is in-service.

### BRIEF DESCRIPTION OF THE DRAWINGS

FIG. 1 is a block diagram providing an abstract illustration of the principal monitorable and controllable subsystems of a conventional vehicle, including the vehicle on-board controller distributed sensor and control network and the base and portable remote diagnostic units as implemented in accordance with a preferred embodiment of the present invention;

FIG. 2 is a simplified block diagram of a preferred implementation of the base diagnostic control unit as constructed in accordance with the present invention;

FIG. 3 is a simplified block diagram of a preferred implementation of the portable diagnostic control unit as constructed in accordance with the present invention;

FIG. 4 provides a block diagram illustrating functional components of the base diagnostic control unit in relation to the vehicle on-board controller and vehicle sensor and control network in accordance with a preferred embodiment of the present invention;

FIG. 5 provides a functional block diagram illustrating the internal functional components of the portable diagnostic control unit in accordance with a preferred embodiment of the present invention;

FIG. 6 is a flow diagram illustrating the operation of the portable diagnostic control unit in accordance with a preferred embodiment of the present invention; and

FIG. 7 is a flow diagram further detailing the autonomous selection and service condition dependent test scheduler as implemented in the portable diagnostic control unit in accordance with a preferred embodiment of the present invention.

### DETAILED DESCRIPTION OF THE INVENTION

Along with the increasing complexity of embedded computer-based automobile control systems, and vehicular control systems in general, there is an increasing demand for improved monitoring and control of these systems generally for the purpose of optimizing performance and minimizing the costs of maintenance. The present invention is directed at providing an efficient, effective diagnostic system capable of monitoring performance and predictively identifying potential as well as actual failures of vehicle system components. For ease of use, the diagnostic system of the present invention is capable of autonomous operation in general and specifically in selection of vehicle system tests to actively identify potential vehicle operating problems. In the following detailed description of the invention like reference numerals are used to designate like parts depicted in one ore more of the figures.

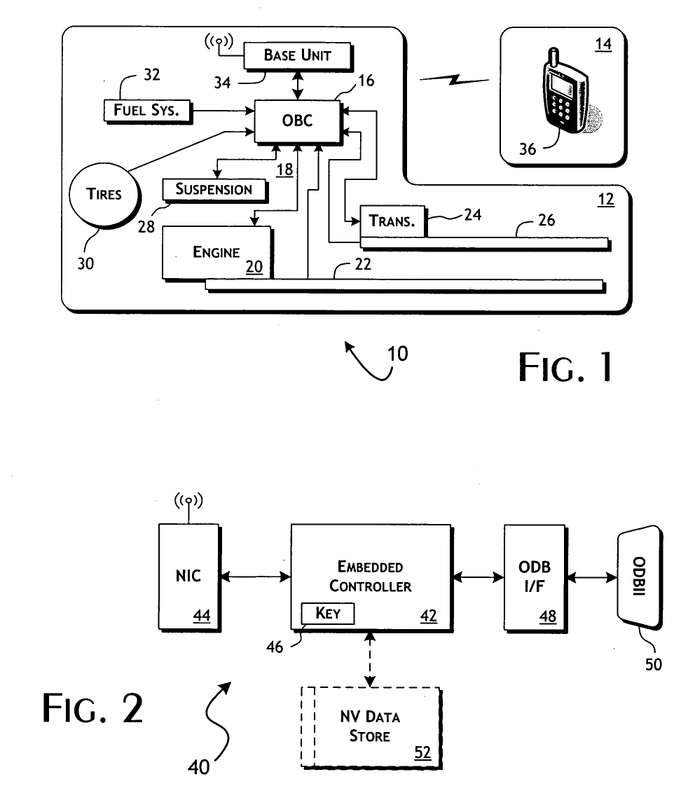

FIG. 1 provides a representation of a conventional automotive system 10 further including a preferred embodiment of the present invention. As shown, the system 10 includes an engine compartment and chassis 12 and passenger compartment 14. An on-board vehicle controller 16 installed within the engine compartment 12 is connected by a distributed sensor and actuator network 18 to the various component sensors and component actuators (not shown) conventionally implemented to monitor and modify the operation of different vehicle components. In general, sensors and actuators are distributed throughout vehicle to monitor and control the operation of the engine 20, exhaust system 22, transmission 24, drive train 26, active suspension 28 and tires 30, and the fuel system 32. The different sensor data sources and controllable features of these components are well-known and further dependent on the specific make and model of the automobile system 10.

In accordance with the present invention, the diagnostic controller implemented as the preferred embodiment is constructed as a two-component system. A base diagnostic controller 34 is preferably installed at or close to the standard Data Link Connector (DLC) port of the on-board vehicle controller 16. The base diagnostic controller 34 is thus generally concealed either within the engine compartment 12 or under the dashboard (not shown) within the passenger compartment 14. OBDII standard protocol support is implemented by the base diagnostic controller 34 to enable communications with the on-board vehicle controller 16.

The base diagnostic controller 34 preferably implements a wireless transceiver to enable a communications connection with a remote diagnostic controller 36. Any conventional short range, modest bandwidth wireless protocol can be used. Initially, preferred embodiments of the present invention use the Bluetooth™ standard communications protocol. The bandwidth limit of one megabit per second and range of less than ten meters is considered adequate. Alternate wireless protocols, such as the Wi-Fi® 802.11b/g standard, can be readily used instead.

For the preferred embodiments of the present invention, the remote diagnostic controller 36 is a hand portable unit with built-in display, keyboard, and wireless transceiver. The remote diagnostic controller 36 also preferably operates as the host platform for the diagnostic control system of the present invention. That is, for the preferred embodiments, the base diagnostic controller 34 functions, at a minimum, as a logical protocol converter to support passage of OBDII commands and data between the on-board vehicle controller 16 and remote diagnostic controller 36. Optionally, in the absence of an active connection with the remote diagnostic controller 36, the base diagnostic controller 34 can also function to receive, record and compile sensor data collected from the distributed sensor network 18. The remote diagnostic controller 36, when supporting an active connection to the base diagnostic controller 34, preferably performs the data analysis and test control operations necessary to evaluate and invoke tests against the operation of the various automotive components 20 through 32. For the initially preferred embodiments of the present invention, the remote diagnostic controller 36 supports a single active connection that allows monitoring and control interaction with a corresponding single automotive system 10. The remote diagnostic controller 36, in alternate embodiments, can support multiple concurrent connections, allowing active monitoring and control interaction with multiple automotive systems 10. For these alternate embodiments in particular, use of the Wi-Fi® 802.11b/g wireless protocol is preferred.

Referring to FIG. 2, a preferred architectural implementation 40 of a base diagnostic controller 34 is shown. The central component is preferably a conventional embedded controller 42, typically implemented as a microprocessor-based control module that incorporates a conventional network stack and a network interface controller 44, shown separately. For example, a conventional module incorporating an Intel® 206 MHz SA-1110 StrongARM low power embedded processor system with TCP/IP stack or similar could be used. As is also conventional, the embedded controller 42 supports an encryption key 46 to secure access to the base diagnostic controller 34. The embedded controller 42 is preferably augmented with an interface circuit 48 to support the electrical requirements of connecting with the on-board vehicle controller 16 through a DLC connector 50. In alternate embodiments of the present invention, an additional non-volatile data store 52 is provided to support extended data capture operations by the embedded controller 42.

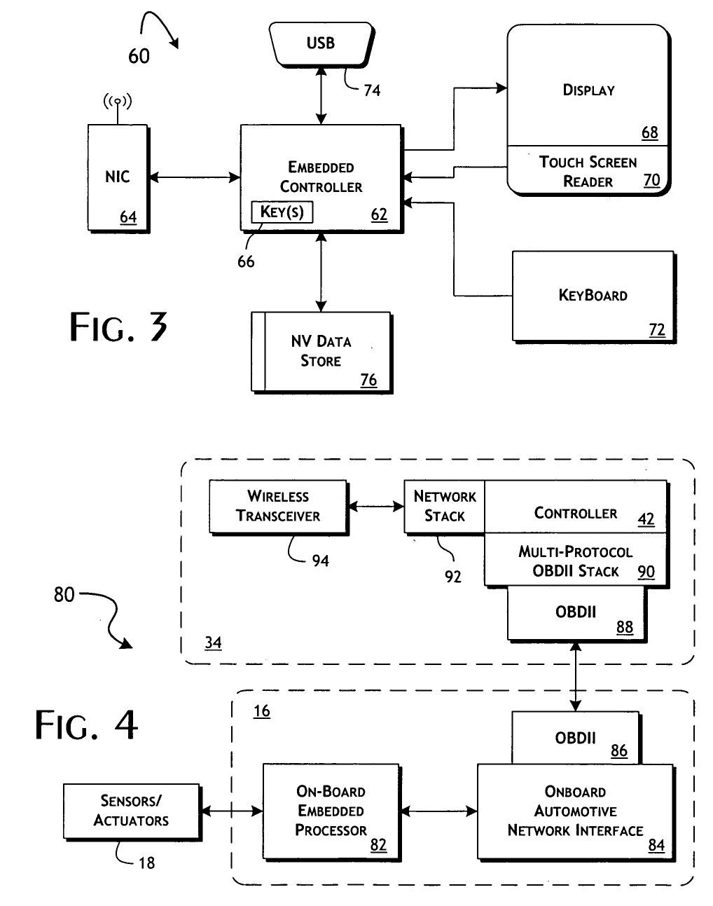

A preferred architectural implementation 60 of a remote diagnostic controller 36 is shown in FIG. 3. A higher performance conventional embedded controller 62, at least relative to the embedded controller 42, is preferably used. The embedded controller 62 includes or is provided with a network controller 64 and an on-board network stack that provides wireless network protocol management support including support for multiple encryption keys 66, preferably corresponding to respective base diagnostic controllers 34. The remote diagnostic controller 36 also preferably includes a flat panel display 68, optionally a touch screen 70, and keyboard 72. The embedded controller 62 preferably includes a flat panel display controller and I/O ports necessary to support these components 68, 70, 72. For example, conventionally available embedded controller modules based on the 400 MHz Intel® PXA255 XScale application processor include Bluetooth and Ethernet network controllers, corresponding network stacks, various serial and parallel I/O ports, and a flat panel display controller. Functionally equivalent, higher performance processor-based modules based on the Intel® Pentium® M processor are also conventionally available and may be preferred particularly where multiple concurrent network connections are to be maintained with multiple base diagnostic controllers 34.

For the preferred embodiments, the keyboard 72 may be provided in addition to or optional where the touch screen 70 is provided. A universal serial bus (USB) interface port 74 is also preferably supported. Finally, the remote diagnostic controller 36 also preferably includes a non-volatile data store 76. As will be discussed in greater detail below, the non-volatile data store 76 preferably provides persistent storage for historical data and other data developed during the operation of the remote diagnostic controller 36.

The preferred function 80 of the base diagnostic controller 34 in relation to the on-board vehicle controller 16 is generally illustrated in FIG. 4. The distributed sensor and actuator network 18 typically connects to an embedded on-board processor system 82 internal to the on-board vehicle controller 16. An OBDII network protocol interface and OBDII port 86 support standard OBDII external communications. The base diagnostic controller 34, in turn, presents a standard OBDII port 88 interface to a multi-protocol OBDII stock 90 executed by the embedded controller 42. The embedded controller 42 also preferably executes a network stack 92 corresponding appropriately to the implemented wireless transceiver 94 implemented by the base diagnostic controller 34.

In executing the multi-protocol OBDII stack 90, the controller 42 iterates through the variants of the standard protocols supported through the OBDII port 88 to establish bi-directional communications with the on-board embedded processor 82. The embedded controller 42 is thus able to receive a parametric data stream generated in response to the actions and reporting of operational parameters by the on-board embedded processor 82 and any subsidiary on-board embedded processors operating in connection with the sensor and actuator network 18. Additionally, specific data can be retrieved by or through the embedded controller 42 based on the presentation of test code defined query commands to the OBDII port 88. Additionally, OBDII defined diagnostic test commands (DTCs) can be issued through the OBDII port 88 to initiate specific diagnostic tests by the on-board embedded processor 82 and receive the test results either as specific returned data or indirectly through ongoing monitoring of the returned data stream.

FIG. 5 presents a preferred functional organization of the control system 100 implemented on the embedded controller 62 of the remote diagnostic controller 36 in accordance with the present invention. A central master data controller 102 is responsible for managing the bi-directional transfer of commands and data through a network stack 104 and wireless transceiver 106 with respect to a base diagnostic controller 34. Specifically, the master data controller 102 recognizes, prioritizes, and routes incoming data based on type and intended use. Typically following initialization of a connection with a base diagnostic controller 34, the remote diagnostic controller requests and begins receiving the parametric data stream generated by the on-board embedded processor 82. Additionally, data generated in response to specific diagnostic test commands and other query and control commands issued to the on-board embedded processor 82 are received for routing by the master data controller 102.

Received data, including in particular the parametric data stream, are routed to a storage manager 108 for selective storage in a data store 110. The storage manager 108 preferably manages a database established within the data store 112 to collect and store a historical record of the parametric data stream and record the time and results of particular diagnostic test commands and other commands issued to a particular base diagnostic controller 34. To accommodate parametric data streams and command data results that may present parametric values in greater or different detail and at different rates, the storage manager 108 may perform a standardizing or normalizing filter function on the data as received and further restricted by an identification of the particular parameters tracked in general or specifically for a particular vehicle. All accesses to the database formed in the data store 110 are preferably managed through the storage manager 108. The size of the data store 110 will depend on the size of the underlying physical data storage medium, which may be fixed, variable, or removable.

For the preferred embodiments of the present invention, an expert rules module 112 is preferably implemented to inferentially track, diagnose, and, at appropriate times, initiate further diagnostic tests evaluate the condition of a vehicle being monitored by a remote diagnostic controller 36. The default rule set and, optionally, dynamically developed rules used by the expert rules module 112 are stored and retrieved through the storage manager 108 in the data store 110. Preferably, the expert rules module 112 implements a basic rule-based, backwards chaining inference engine that accepts vehicle parametric data as inputs. Preferably, both parametric data from the current parametric data stream and parametric data preserved from prior operating cycles, as retrieved through the storage manager 108, are used as inputs.

The rule set is preferably established to inferentially adapt to and monitor the operating condition of a monitored vehicle. The rule set is further established to guide the selection of and control the timing of different diagnostic tests to be performed. These tests include the OBDII defined diagnostic test commands issued to obtain specific corresponding test data.

In addition, in accordance with the present invention, the rule set will initiate various prognostic test routines, implemented by the issuance of one or more commands, to the on-board embedded processor 82 to perturb specific operating condition aspects to diagnostically examine dynamically induced variations in the operating conditions of the vehicle. For example, a test routine may be used to force a variance in the values reported by different engine-based oxygen sensors in order to observe the induced reaction of other engine components. This enables the expert rules module 112 to evaluate the specific operating condition of the oxygen sensor itself as well as the function and efficiency of other sensors and the on-board embedded processor 82 in recognizing and adjusting to different operating conditions. The inability of a component to react is preferably recognized as a fault condition. Inefficiency or inappropriateness in the reaction of components is preferably recognized as predictive of a fault condition. Where such a variance is observed, the expert rules module 112 may direct the execution of additional prognostic tests routines to validate and establish a confidence level in the existence of an existing or predicted fault.

Further, the expert rules module 112 may and typically will manage and monitor the results of multiple prognostic tests routines at a given time in the operation of a vehicle. In accordance with the present invention, the execution of prognostic tests, or even of the diagnostic test commands, is not limited to a service bay or other out-of-service context. In evaluation of the rule set, the expert rules module 112 preferably determines the operating conditions, such as at different engine and air temperature combinations, at different vehicle speeds maintained for different periods of time, and different rates of acceleration, at which a particular diagnostic test is to be performed. The diagnostic tests may be re-run under many different combinations of operating conditions to elicit a broad if not comprehensive set of sensor data for analysis. Such comprehensive in-service prognostic testing, which cannot be simulated in a service bay only context, enables systems implementing the present invention to readily identify and predict the existence of fault conditions in the operation of a vehicle being monitored. This vehicle condition prognostics capability allows a vehicle operator to be alerted immediately to new actual fault conditions and of impending problems before an identified component or condition failure affects the vehicle.

The tests selected by the expert rules module 112 are preferably executed under the control of a diagnostic test manager 114. The diagnostic test manager 114 is also responsible for directing the periodic performance of additional tests used to update the remote diagnostic controller 36 with the operational status of the vehicle and the standard and manufacturer defined air quality and fuel usage tests used to certify the vehicle meets appropriate regulatory standards. Further tests, determined in response to the receipt of diagnostic trouble codes generated in the normal operation of the on-board embedded processor 82, are also managed by the diagnostic test manager 114. In the preferred embodiments of the present invention, the diagnostic test manager 114 includes a scheduler that handles deferred execution of tests as tasks pending recognition of a particular, including in-service, vehicle operating state or condition reflecting an appropriate and safe opportunity to initiate execution of a corresponding test. Execution of diagnostic tests during in-service operation are performed subject to determined safe vehicle operating parameters, such as appropriate velocity and braking conditions, and automatically aborted where continued safe operation of the vehicle might be compromised.

A local reporting and control system 116 supports presentation of system information diagnostic results, and suggested actions to a user of the remote diagnostic controller 36. A display system 118, supporting the display devices 68, presents user readable information in the form of text and graphics. Preferably, based on the interoperation of the expert rules module 112 and local reporting and control system 116, current status and recommended action information are presented in a concise, natural language representation that can be varied to reflect different user levels of understanding of the source and nature of different present and predicted fault conditions. Commands from buttons and menus received through a user input system 120, supporting the touch screen 70 and keyboard 72 devices are interpreted and implemented, as appropriate, by the remote diagnostic controller 36.

A firmware management and data retrieval controller 122 is preferably provided to allow external access to the parametric data and to update the default rules set stored by the data store 110. An external I/O interface, preferably supported by the universal serial bus device 74 of the remote diagnostic controller 36, allows connection of an external computer system (not shown). The firmware management and data retrieval controller 122 preferably implements a basic access security protocol and further mediates access through the storage manager 108 to the data store 110. Revised expert rules can be stored to the data store for subsequent use by the expert rules module 112 and historical parametric data can be downloaded from the remote diagnostic controller 36 for long term external storage and, potentially, further analysis.

A preferred operational flow for the remote diagnostic controller 36 is shown in FIG. 6. A conventional real-time operating system is implemented on the embedded controller 62 to support interrupt driven task execution. In response to network interface controller interrupts, data packets are received and processed with the underlying data routed 132 dependent on data content type. Data reflecting vehicle current operating conditions are routed to the task executing the expert rules inference engine 134 for evaluation. Depending on the inference execution, additional rules are drawn from the expert rules data store 136 and applied. Specific diagnostic test data may be discretely routed for filtering and pre-processing 138, principally to reduce volume and normalize parameterized values, prior to being applied to the expert rules inference engine 134. Alternately, any required filtering and preprocessing 138 may be performed directly by the expert rules inference engine 134.

Operating condition parametric data and, to the extent different, current vehicle operating condition data, is routed 132 for evaluation and storage 140 in a parametric data store 142. In accordance with the present invention, the data routing is prioritized with the goal of ensuring that operating condition and test result data is promptly transferred to the expert rules inference engine 134 for evaluation. Parametric data intended for storage and for subsequent historical reference is accorded a lower routing and processing priority.

In the ongoing execution of the expert rules inference engine 134, the expert rules set preferably implements a prognostic directed analysis. In effect, in evaluating the likely confidence of different possible fault conditions identified from analysis of the applied and retrieved historical operating condition parametric data, as well as current vehicle operating condition data, the expert rules inference engine 134 identifies diagnostic tests for execution that, when executed under identified vehicle operating conditions, are intended to produce test data most likely to affect the confidence associated with the possible fault condition. Additionally, the expert rules inference engine 134 preferably recognizes the occurrence of diagnostic trouble codes received in the course of the current vehicle operating condition data. In response to specific diagnostic trouble codes, the expert rules inference engine 134 may elect to run one or more diagnostic tests to clarify the source and nature of the problem summarily identified by a diagnostic trouble code.

When the expert rules inference engine 134 identifies a diagnostic test for execution, the test and intended operating conditions for the execution of the test are provided to a command diagnostic test task 144. This task is responsible for managing the potentially deferred execution of the requested test. When the appropriate conditions are recognized, the command diagnostic test task 144 schedules and sequentially issues the series of one or more OBDII commands necessary to implement the test.

A user interface task 146 supports user directed selection of data presentation views. Raw and processed parametric data, accessed from the parametric data store 142, is preferably user selectable for presentation both textually and graphically in multiple different views. Natural language representations of the vehicle current operating state and recommended actions to be taken, if any, are presented from the expert rules inference engine 134. Additionally, user directed selection of one or more tests to be run is supported. When a user-selected test is selected, a corresponding test identification is made to the command diagnostic test task 144.

Ancillary tasks implemented by the embedded controller 62 include handling requests to retrieve and export the historical parametric data 148 and to receive update firmware for the remote diagnostic controller 36 potentially including an updated default expert rules set. These tasks are preferably invoked in response to an I/O interrupt, typically received from the universal serial bus device 74. In an alternate embodiment of the present invention, these tasks may be invoked from and execute a wireless connection with an external computer system, rather than requiring a direct serial connection with the remote diagnostic controller 36.

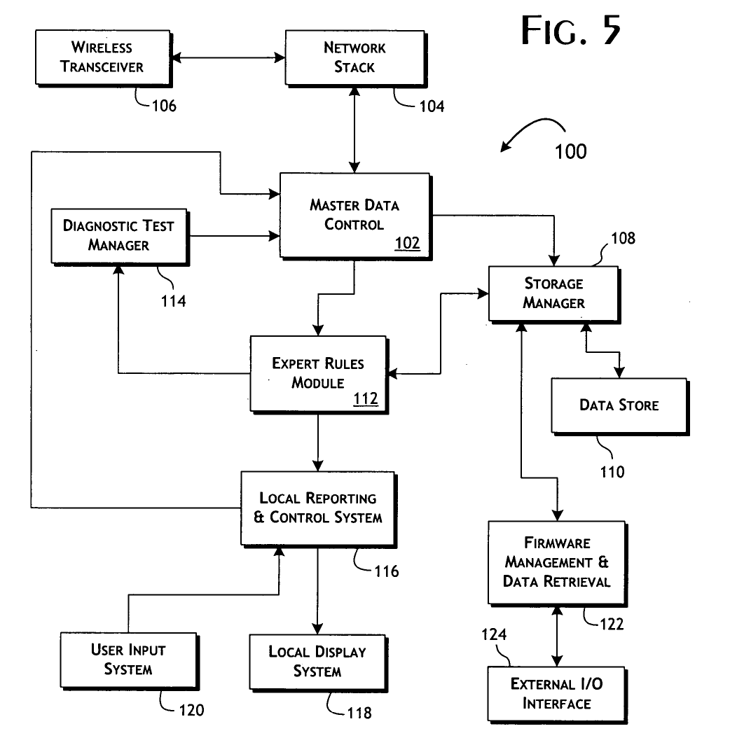

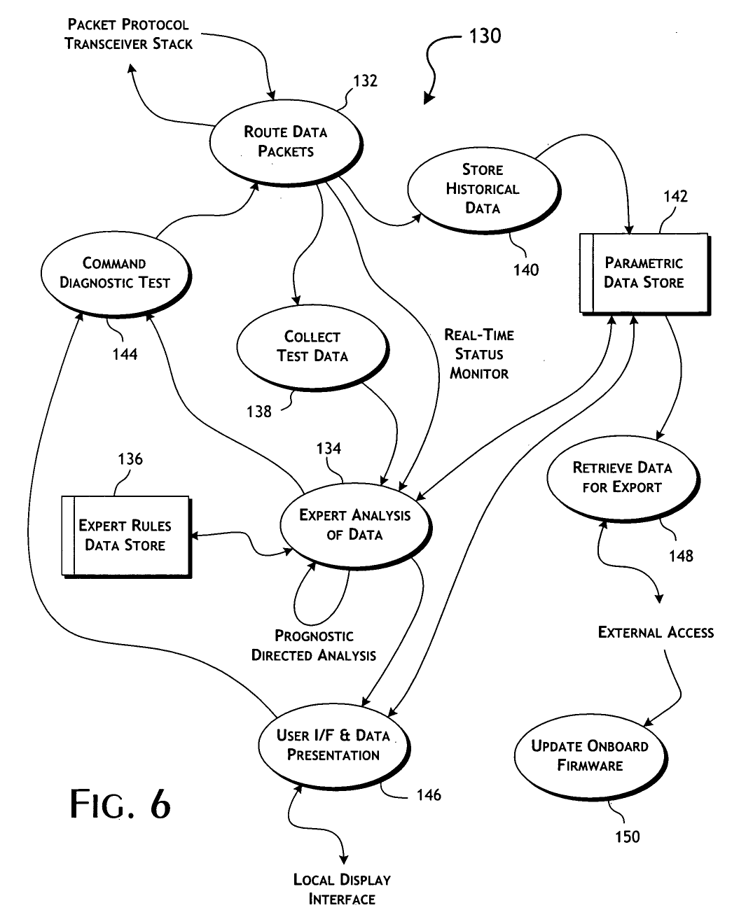

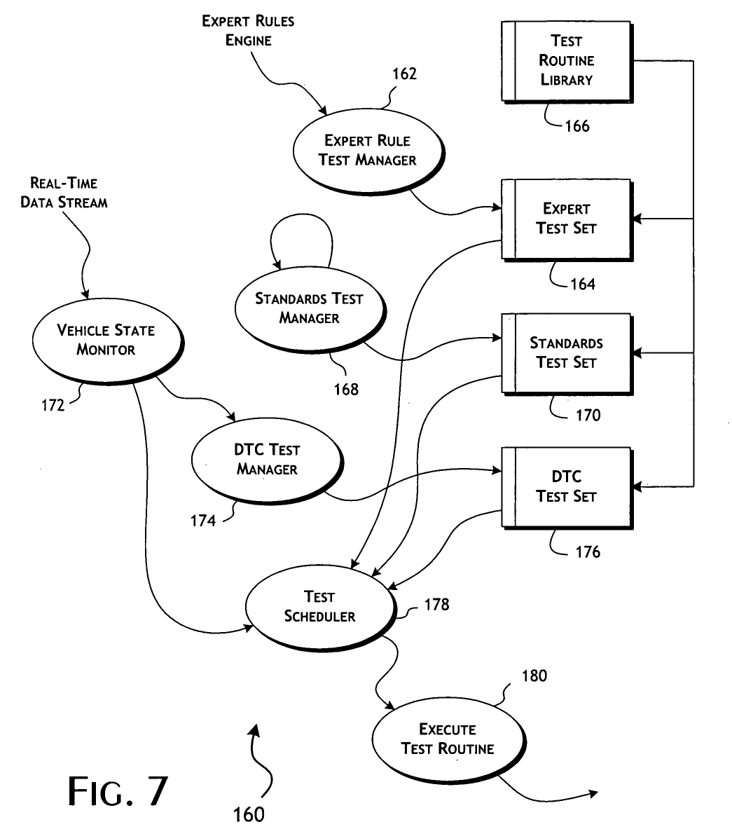

A detailed view of the preferred flow implementing deferred and scheduled test execution 160 is provided in FIG. 7. Preferably in the execution of the expert rules inference engine 134, a potential fault condition is further analyzed by inference rules to identify 162 a prognostic test and the appropriate conditions under which to execute the test. A corresponding test identifier is stored to an expert test set 164. The stored identifier includes both a specification of the required the execution test conditions and of the test to be performed. In a preferred embodiment of the present invention, the specification of the test to be performed is provided simply by a reference to test specification stored in a test routine library 166. The library 166 may be implemented as a discrete database established within the data store 110 or as a series of rules within the rule base itself. Each of the test routines in the library 166 contains a sequence of one or more OBDII commands that, as sequentially issued to an on-board embedded processor 82, implements the corresponding test.

Standard tests and tests desired to be periodically executed 168 are identified and stored to a standards test set 170. As with the prognostic tests, these tests identify the desired vehicle operating condition under which to execute the test and a reference to a test library routine that defines the test to be executed.

Finally, the expert rules inference engine 134 preferably monitors 172 for the occurrence of diagnostic tests codes within the current parametric data stream. When a diagnostic test code is identified, the current operational conditions surrounding the diagnostic test code event are considered by the expert rules inference engine 134 and, as appropriate to better identify the source and nature of the cause of the diagnostic test code event, one or more further tests are identified 174 and stored to a DTC test set 176. The stored identifier specifies the appropriate conditions under which the test is to be executed and a reference to a corresponding test routine within the test library 166.

In accordance with the present invention, a test scheduler 178 executes as part of the diagnostic test manager 114 to evaluate the various stored test identifiers against the current operational conditions of the vehicle as determined from the vehicle state monitor 172. Whenever a test identifier is qualified by the test scheduler 178, the identifier is selected 180 for execution. The diagnostic test manager 114 references the corresponding test routine in the test routine library 166 and initiates execution by issuing the included instructions to the on-board embedded processor 82.

Thus, a system and methods for actively monitoring and diagnosing both existing and potential component fault conditions have been described. While the present invention has been described particularly with reference to a two component design, supporting mobile use of the remote component, the present invention can be implemented as a fixed unit implemented entirely within a single vehicle. The present invention can equally be implemented with the remote unit operating as a fixed and non-portable station capable of monitoring a fleet of vehicles through wide area network connections.

In view of the above description of the preferred embodiments of the present invention, many modifications and variations of the disclosed embodiments will be readily appreciated by those of skill in the art. It is therefore to be understood that, within the scope of the appended claims, the invention may be practiced otherwise than as specifically described above.

1. A diagnostics control system operable to manage an on-board vehicle control system to support active diagnosis of current operating and potential fault conditions in the operation of the vehicle, said diagnostics control system comprising:
a diagnostic controller, coupleable to an on-board vehicle control system installed within a vehicle, operative to exchange commands and data with said on-board vehicle control system, said diagnostic controller implementing a control system providing for the autonomous execution of diagnostic tests dependent on the operational state of said vehicle, said control system including:
I) a diagnostics control manager operative to select a diagnostic test routine for execution by said diagnostic controller, wherein said diagnostic test routine includes one or more predefined commands that, by execution, are issued to said on-onboard vehicle control system, said diagnostics control manager being further operative to define an in-service operational state at which to execute said diagnostic test routine;
ii) a monitor, responsive to sensor data retrieved in real-time from said on-board vehicle control system, operative to detect a current instance of said in-service operational state of said vehicle; and
iii) a diagnostic test scheduler, responsive to said monitor, operative to initiate execution of said diagnostic test routine upon detection of said current instance.

2. The diagnostics control system of claim 1 wherein said control system includes a test queue, wherein said diagnostics control manager is operative to post said diagnostic test routine to said test queue pending occurrence of said in-service operational state and wherein said diagnostic test scheduler is operative to select said diagnostic test routine from said test queue upon detection of said current instance, whereby execution of said diagnostic test routine is deferrable until specific vehicle in-service conditions appropriate for conducting the diagnostic test exist.

3. The diagnostics control system of claim 2 wherein said diagnostics control manager, responsive to sensor data retrieved from said on-board vehicle control system, is operative to autonomously select said diagnostic test routine, from among a plurality of diagnostic test routines, for execution.

4. The diagnostics control system of claim 3 wherein said control system further includes an expert system responsive to sensor data retrieved from said on-board vehicle control system, wherein said expert system is operative to autonomously command selection by said diagnostics control manager of said diagnostic test routine, from among a plurality of diagnostic test routines, for execution.

5. The diagnostics control system of claim 4 wherein said diagnostic controller includes first and second components, wherein said first component is installable on-board said vehicle coupled to said on-board vehicle control system to provide for the exchange of commands and data with said on-board vehicle control system, said first diagnostic controller component including a first wireless transceiver, and wherein said second component is implemented as a hand portable device including a display coupled to said control system to display data representative of the results of the execution of said diagnostic test routine following from detection of said current instance, said second component including a second wireless transceiver through which said second component is interoperable with said first component for the exchange of commands and data.

6. A method of autonomously analyzing the operation of a vehicle having an on-board vehicle control system implementing a network of sensors and controls with respect to a plurality of vehicle components for managing the operation of said vehicle, said method comprising the steps of:
a) autonomously determining, by a diagnostic controller coupleable to said on-board vehicle control system for the exchange of commands and data, a diagnostic test routine to be executed by said diagnostic controller at a specified operating state of said vehicle, wherein execution of said diagnostic test routine provides for the communication of a sequence of one or more commands to said on-board vehicle control system, and wherein said specified operating state is one of a plurality of predetermined operating states including in-service operating states;
b) receiving, by said diagnostic controller, a real-time stream of sensor data reflective of the operating state of said vehicle;
c) evaluating, by said diagnostic controller, said real-time stream of sensor data to identify an occurrence of said specified operating state;
d) executing, upon identification of said occurrence of said specified operating state, said diagnostic test routine; and
e) analyzing, by said diagnostic controller, said real-time stream of sensor data to identify a faulting component.

7. The method of claim 6 wherein said step of analyzing provides information potentially reflective of the identity of said faulting component to said step of autonomously determining and wherein said step of autonomously determining provides for the repeated determining to execute one or more of a plurality of diagnostic test routines to enable said step of analyzing to confirm the identity of said faulting component.

8. The method of claim 7 wherein said step of analyzing provides for an expert rules based analysis of said real-time stream of sensor data.

9. The method of claim 8 wherein said step of analyzing further provides for the predictive identification of said faulting component.

10. The method of claim 9 wherein said diagnostic controller includes a first component installed in said vehicle and coupled to said on-board vehicle control system and a second component wirelessly coupleable to said first component for the exchange of commands and data.

11. The method of claim 10 further comprising the step of accumulating a historical record of said real-time stream of sensor data and wherein said step of analyzing includes analyzing said historical record.

12. The method of claim 11 wherein said second component includes a display and wherein said step of analyzing includes the step of presenting, via said display, a representation of the identity of said faulting component.

13. A diagnostics control system operable to manage an on-board vehicle control system to support active diagnosis of current operating and potential fault conditions in the operation of the vehicle, said diagnostics control system comprising:
a) a first diagnostic controller component installable on-board a vehicle coupled to an on-board vehicle control system to provide for the exchange of commands and data with said on-board vehicle control system, said first diagnostic controller component including a first wireless transceiver; and
b) a second diagnostic controller component including a second wireless transceiver through which said second diagnostic controller component is interoperable with said first diagnostic controller component for the exchange of commands and data, said second diagnostic controller component implementing a control system providing for the autonomous execution of diagnostic tests dependent on the operational state of said vehicle, said control system including:
I) a diagnostics control manager operative to select a diagnostic test routine for execution by said second diagnostic controller component, wherein said diagnostic test routine includes one or more predefined commands that, by execution, are issued to said on-onboard vehicle control system, said diagnostics control manager being further operative to define an in-service operational state at which to execute said diagnostic test routine;
ii) a monitor, responsive to sensor data retrieved in real-time from said on-board vehicle control system, operative to detect a current instance of said in-service operational state of said vehicle; and
iii) a test scheduler, responsive to said monitor, operative to initiate the execution of said diagnostic test routine upon detection of said current instance.

14. The diagnostics control system of claim 13 wherein said second diagnostic controller component is implemented as a hand portable device including a display coupled to said control system to display data representative of the results of the execution of said diagnostic test routine following from detection of said current instance.

15. The diagnostics control system of claim 14 wherein said control system includes a test queue, wherein said diagnostics control manager is operative to post said diagnostic test routine to said test queue pending occurrence of said in-service operational state and wherein said test scheduler is operative to select said diagnostic test routine from said test queue upon detection of said current instance.

16. The diagnostics control system of claim 15 wherein said diagnostics control manager, responsive to sensor data retrieved from said on-board vehicle control system, is operative to autonomously select said diagnostic test routine, from among a plurality of diagnostic test routines, for execution.

17. The diagnostics control system of claim 16 wherein said control system further includes an expert system responsive to sensor data retrieved from said on-board vehicle control system, wherein said expert system is operative to autonomously command selection by said diagnostics control manager of said diagnostic test routine, from among a plurality of diagnostic test routines, for execution.
